(19) United States
(12) Patent Application Publication
(10) Pub. No.: US 2009/0242282 A1
(43) Pub. Date: Oct. 1, 2009

(54) Apparatus and Method for Providing Interface Depending on Action Force, and Recording Medium Thereof

(75) Inventors: Jong Ho Kim, Daejeon (KR); Dae Im Kang, Daejeon (KR); Yon Kyu Park, Daejeon (KR); Min Seok Kim, Daejeon (KR); Jae Hyuk Choi, Daejeon (KR)

Correspondence Address: AKERMAN SENTERFITT, P.O. BOX 3188, WEST PALM BEACH, FL, 33402-3188, US

(73) Assignee: Korea Research Institute of Standards and Science, Daejeon (KR)

(21) Appl. No.: 12/186,865

(22) Filed: Aug. 6, 2008

(30) Foreign Application Priority Data
Apr. 1, 2008 (KR) 10-2008-0030188

(51) Int. Cl. G06F 3/041

(52) U.S. Cl. 178/18.03

(57) ABSTRACT

The present invention relates to an apparatus for providing a user interface depending on an action force, the apparatus comprising: a touch input unit for allowing a user to input a position or operation command thereto using a pointing object, being applied with the action force of the pointing object, and recognizing the applied position information; a tactile sensor placed on a bottom surface of the touch input unit, for detecting the action force and generating a predetermined signal; a control unit for determining an expression value of a transfer medium in response to the signal generated from the tactile sensor; and an expression unit for expressing the strength of the action force by outputting the transfer medium based on the expression value of the control unit.

### BACKGROUND OF THE INVENTION

1. Field of the Invention

The present invention relates to an apparatus and method for providing a user interface and a recording medium thereof, and particularly, to an apparatus and method for providing a user interface and a recording medium thereof, in which a variety of interfaces is provided depending on strength of an action force Fᵢₙ applied to a portable terminal by a user with a pointing object (e.g., a finger of the user, a stylus tip, or the like). More specifically, the present invention relates to an apparatus for providing a user interface, a method for providing a user interface using the apparatus, and a recording medium thereof, in which the apparatus comprises a touch input unit 210 that is a medium for allowing a user to input a position or operation command thereto using a pointing object 1, being applied with an action force Fᵢₙ of the pointing object 1, and recognizing the applied position information; a tactile sensor 220 placed on the bottom surface of the touch input unit 210, for detecting the action force Fᵢₙ and generating a predetermined signal; a control unit 230 for determining an expression value of a transfer medium in response to the signal generated from the tactile sensor 220; and an expression unit 240 for expressing the strength of the action force Fᵢₙ by outputting the transfer medium based on the expression value of the control unit 230.

2. Background of the Related Art

A user interface is a technique for allowing general users to control the input of data or operation in a program of a computer or an electronic/communication device. The fundamental object of the user interface is to allow a user to conveniently and easily communicate with the computer program.

Presently, computers and electronic/communication devices are tools for further enhancing creativity of users, and the user interface supports such activities and greatly contributes to improve convenience of the users.

A conventional user interface is based on a method of using a mouse, in which if the mouse is clicked, on/off is expressed as a sound of ‘click’. That is, in informing a user of a fact that an operation command has been inputted, the input of the operation command is expressed by only a sound having a constant amplitude and tone (e.g., a sound of clicking).

Although the computers, electronic/communication devices (particularly, portable terminals) and the like are tools for further enhancing creativity of users in the present days, the conventional user interfaces employ a simple expression method as described above, and thus there is a problem in that the user interfaces may put limitation on supporting a variety of activities of the computers and electronic/communication devices.

Furthermore, since the conventional user interfaces express only an on/off state, there is a limitation in satisfying five senses of users.

### SUMMARY OF THE INVENTION

Therefore, the present invention has been made in an effort to solve the above problems, and it is an object of the present invention to provide a variety of user interfaces depending on the strength of an action force Fᵢₙ applied by a user with a pointing object in an electronic/communication device attached with tactile sensors, particularly in a portable terminal.

To accomplish the above object, in one aspect of the present invention, there is provided an apparatus for providing a user interface, the apparatus comprising: a touch input unit 21 for allowing a user to input a position or operation command thereto using a pointing object, being applied with the action force of the pointing object, and recognizing the applied position information; a tactile sensor placed on a bottom surface of the touch input unit, for detecting the action force and generating a predetermined signal; a control unit for determining an expression value of a transfer medium in response to the signal generated from the tactile sensor; and an expression unit for expressing the strength of the action force by outputting the transfer medium based on the expression value of the control unit.

Also, the transfer medium is at least one of an indicator icon, sound, and vibration.

In addition, the indicator icon is a level meter icon, 7-segment digital icon, bar icon, or gauge icon.

Further, the apparatus for providing a user interface operates when an action force greater than a minimum force previously set by a user is applied.

In another aspect of the present invention, there is provided a method for providing a user interface, the method comprising the steps of: allowing a tactile sensor to detect the action force and generate a signal corresponding to the action force; allowing a control unit to determine an expression value of a transfer medium based on the signal generated from the tactile sensor; and expressing the strength of the action force as an indicator icon based on the expression value.

In addition, the indicator icon is displayed at a previously specified position of a display unit of a portable terminal.

In addition, the indicator icon appears for a few seconds at a position where the action force is applied and then disappears.

In addition, the method further comprises the step of allowing, before the step of allowing the tactile sensor to detect the action force and generate the signal corresponding to the action force, a user to select any one of indicator icon display forms of a level meter icon, 7-segment digital icon, bar icon, and gauge icon.

In addition, in the step of expressing the strength of the action force as an indicator icon, the indicator icon is divided into certain sections, and the divided sections are displayed in colors different from one another depending on the strength of the action force.

In addition, a certain sound or vibration is outputted as well as the indicator icon.

In addition, frequency or amplitude of the certain sound or vibration is proportional to the strength of the action force.

In addition, when the indicator icon is expressed, the change of an operation state according to a click event generated by applying the action force is displayed together with the icon.

In still another aspect of the present invention, there is provided a method for providing a user interface, the method comprising the steps of: allowing a tactile sensor to detect the action force and generate a signal corresponding to the action force; allowing a control unit to determine an expression value of a sound based on the signal generated from the tactile sensor; and expressing the strength of the action force as the sound based on the expression value.

In addition, the amplitude or frequency of the sound is proportional to the strength of the action force.

In addition, the action force is divided into certain sections, and the amplitude or frequency of the sound is increased on a step function basis as the strength of the action force is increased in each section.

In addition, in the step of expressing the strength of the action force as a sound, the change of an operation state according to a click event generated by applying the action force is visually expressed together with the sound.

In still another aspect of the present invention, there is provided a method for providing a user interface, the method comprising the steps of: allowing a user to apply the action force; allowing a tactile sensor to detect the action force and generate a signal corresponding to the action force; allowing a control unit to determine an expression value of a vibration based on the signal generated from the tactile sensor; and expressing the strength of the action force as vibration based on the expression value.

In addition, the amplitude or frequency of the vibration is proportional to the strength of the action force.

In addition, the action force is divided into certain sections, and the amplitude or frequency of the vibration is increased on a step function basis as the strength of the action force is increased in each section.

In addition, it is preferable that in the step of expressing the strength of the action force as vibration, the change of an operation state according to a click event generated by applying the action force is visually expressed together with the vibration.

In addition, in the method for providing a user interface, the sound is outputted when the action force is greater than a certain critical force.

In addition, in the method for providing a user interface, the vibration is outputted when the action force is greater than a certain critical force.

There is provided a recording medium for providing a user interface of the present invention, which is readable by a computing system included in an apparatus for providing a user interface depending on an action force, the medium having a program recorded thereon for executing: an action force detecting step for detecting application of the action force; a signal storing step for storing a signal corresponding to the action force generated by a tactile sensor 220; an expression value determining step for determining an expression value of a transfer medium based on the signal; and an expression step for expressing the strength of the action force as an indicator icon, sound, or vibration depending on the determined expression value.

Preferably, the recording medium further includes a program for executing, before detecting application of the action force, a medium selection step that allows a user to previously select at least one of the indicator icon, sound, and vibration as a medium for expressing the strength of the action force.

In addition, the recording medium further includes a program for executing, when the strength of the action force is expressed as an indicator icon, an icon selection step for allowing a user to previously select at least one of indicator icon display forms of a level meter icon, 7-segment digital icon, bar icon, and gauge icon.

An apparatus and method for providing a user interface and a recording medium thereof according to the present invention provide a variety of user interfaces depending on an action force applied by a pointing object in an electronic/communication device attached with tactile sensors, particularly in a portable terminal, and thus a user is allowed to recognize the strength of the action force.

In addition, the present invention may contribute to satisfying five senses of users through the variety of user interfaces and improving convenience of the users in using a portable terminal.

### BRIEF DESCRIPTION OF THE DRAWINGS

The above and other objects, features and advantages of the present invention will be apparent from the following detailed description of the preferred embodiments of the invention in conjunction with the accompanying drawings.

FIG. 1 is a block diagram of an apparatus for providing a user interface depending on an action force.

FIGS. 2a and 2b show arrangement of tactile sensors.

FIG. 3 is a cross sectional view of a tactile sensor.

FIG. 4 is a flowchart illustrating a method for providing a user interface depending on an action force.

FIGS. 5a to 5d are views respectively showing a state of a screen according to an indicator icon type.

FIGS. 6a and 6b are exemplary views of indicator icons showing strength of an action force and changes of operation.

FIGS. 7a, 7b, and 8 are graphs showing relative magnitudes of frequency f or amplitudes A of a sound or vibration with respect to an action force.

FIG. 9a is a view showing a state of a screen when an action force is less than a certain critical force.

FIG. 9b is a view showing a screen and operation state when an action force is greater than a certain critical force.

### DETAILED DESCRIPTION OF THE PREFERRED EMBODIMENT

The preferred embodiments of the invention will be hereafter described in detail, with reference to the accompanying drawings.

<Apparatus for Providing User Interface>

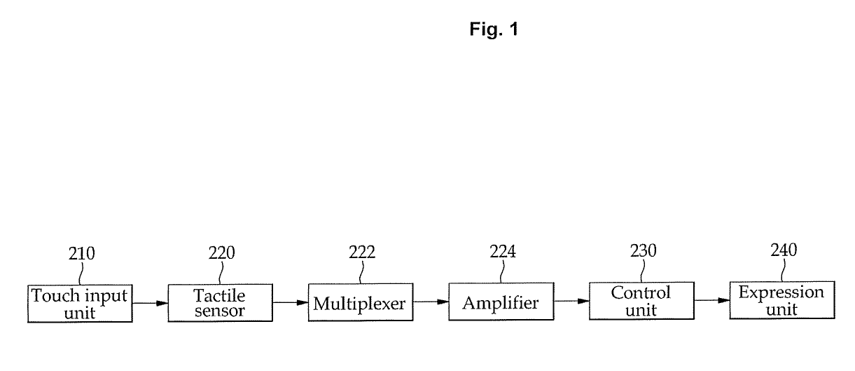

As sown in FIG. 1, an apparatus for providing a user interface depending on an action force Fᵢₙ according to the present invention comprises a touch input unit 210 that is a medium for recognizing position information of a point where the action force Fᵢₙ is applied by a pointing object 1; a tactile sensor 220 placed on the bottom surface of the touch input unit 210, for detecting the action force Fᵢₙ and generating a predetermined signal; a control unit 230 for determining an expression value of a transfer medium in response to the signal generated from the tactile sensor 220; and an expression unit 240 for expressing the strength of the action force Fᵢₙ by outputting the transfer medium based on the expression value of the control unit 230.

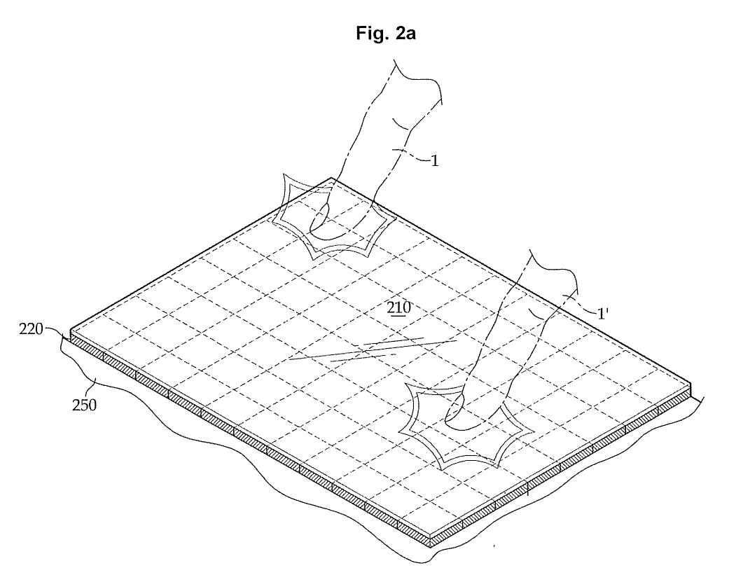

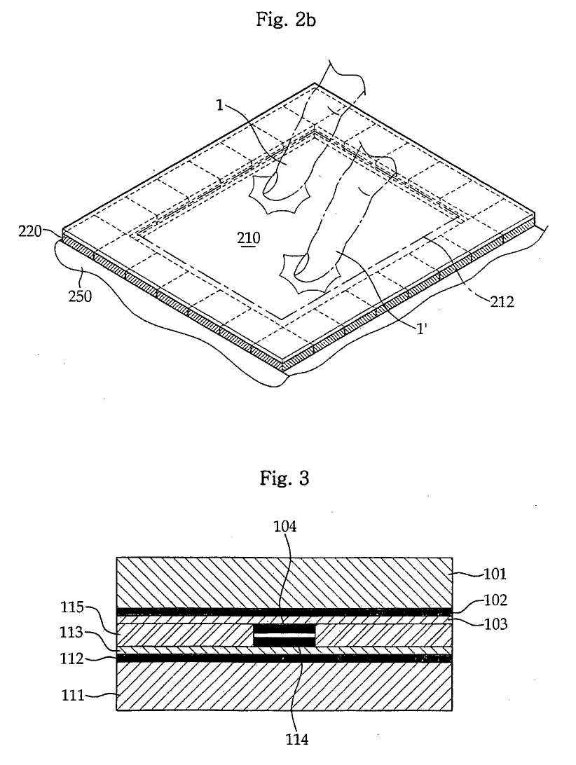

The touch input unit 210 is a medium where an action force Fᵢₙ is applied, which can be a touch pad, touch screen, or the like. It is preferable that tactile sensors 210 are arranged in the form of a matrix as shown in FIG. 2a if the touch input unit 210 is a touch pad that is mainly used in a notebook computer, or tactile sensors 210 are arranged along the edge as shown in FIG. 2b if the touch input unit 210 is a touch screen of a cellular phone, so that the display function of the touch screen is not hindered.

The tactile sensor 220 generates a signal corresponding to the action force Fᵢₙ applied to the touch input unit 220. This signal has a value proportional to the action force Fᵢₙ applied by the user. The tactile sensor 220 is placed on the bottom surface of the touch input unit 210, and it is preferable that a plurality of tactile sensors 220 are arranged as shown in FIGS. 2a and 2b. It is since that using the plurality of tactile sensors 220, action forces Fᵢₙ can be detected even when the action forces Fᵢₙ are applied at a plurality of points in a method of multi-touching or dragging the pointing object 1 and 1′.

FIG. 3 shows the configuration of a tactile sensor 220 comprising an upper plate manufactured by forming a coating layer 102 and a metal layer 103 in order on a polymer film 101 of a certain thickness and forming a resistive element 104 on the metal layer 103, and a lower plate manufactured by forming a coating layer 112 and a metal layer 113 in order on a polymer film 101 of a certain thickness and forming a resistive element 114 on the metal layer 113. The upper plate and lower plate are bonded together including a spacer 115 interposed between them so that the resistive element 104 of the upper plate and the resistive element 114 of the lower plate are faced each other. Specific wiring of the tactile sensor 220 is apparent to those who are skilled in the art, and thus detailed descriptions thereof will be omitted.

The control unit 230 determines an expression value of a transfer medium in response to the signal generated from the tactile sensor 220. The ‘transfer medium’ in the present specification is a means for expressing strength of an applied action force fᵢₙ to a user, which is a higher concept including an indicator icon as a visual element, a sound as an aural element, and vibration as a tactile element. At this point, when the transfer medium is an indicator icon, the expression value of the transfer medium will be determined by the expression form of an icon (a bar icon, gauge icon, 7-segment digital icon, or level meter icon) and the strength of the action force fᵢₙ. When the transfer medium is a sound, the expression value of the transfer medium will be determined by a relation between the number of vibrations f or amplitude A of the sound and the action force fᵢₙ, and when the transfer medium is vibration, the expression value of the transfer medium (vibration) will be determined by a relation between amplitude A of the vibration or the number of vibrations f and the action force fᵢₙ.

The expression unit 240 outputs the transfer medium based on the expression value of each transfer medium determined by the control unit 230. Through the output of the transfer medium, a user may recognize the strength of the action force fᵢₙ. When the transfer medium is an indicator icon, the expression unit 240 is a display unit 212 of a portable terminal, when the transfer medium is a sound, the expression unit 240 is a speaker apparatus, and when the transfer medium is vibration, the expression unit 240 is an actuator or a widely known vibration motor provided in a general cellular phone. Preferably, a piezoelectric actuator, voice coil actuator, polymer actuator, or the like can be used as the actuator. Since the attributes and features of the actuators are apparent to those who skilled in the art, detailed descriptions thereof will be omitted.

Preferably, before being applied to the control unit 230, the signal generated by the tactile sensor 220 is processed through a relay multiplexer 222 for sequentially detecting the signals generated by the tactile sensors 220 and an amplifier 224 for amplifying the signals of the relay multiplexer 222 to a certain level.

Here, various types of amplifiers, such as an analog amplifier, digital amplifier, voltage amplifier, and the like, can be used as the amplifier 224. Preferably, the apparatus further comprises a noise cancellation unit (not shown, e.g., a filter) for removing noises included in the signals generated by the tactile sensor 220. Since the digital amplifier consumes less power and is small in size, it can be easily embedded in a computer, portable electronic product, and the like and manufactured as one ASIC, and thus it is advantageous in that the digital amplifier can be mass produced at a low cost. When the digital amplifier is used, it is preferable that the apparatus further comprises a converter (not shown, an analog-to-digital converter (ADC) or a digital-to-analog converter (DAC)) for converting between analog signals and digital signals.

In addition, the apparatus for providing a user interface preferably operates when the action force Fᵢₙ is greater than a minimum force Fₘ. The minimum force Fₘ means a minimum action force Fᵢₙ that is intentionally applied by a user in order to input a position or operation command in a portable terminal 300. It is to prevent the portable terminal 300 from being operated when the action force Fᵢₙ not for a position or operation command is applied (e.g., when a finger touches the touch input unit by mistake). That is, an action force Fᵢₙ less than the minimum force Fₘ is applied, the portable terminal 300 does not operate.

<Method for Providing User Interfaces>

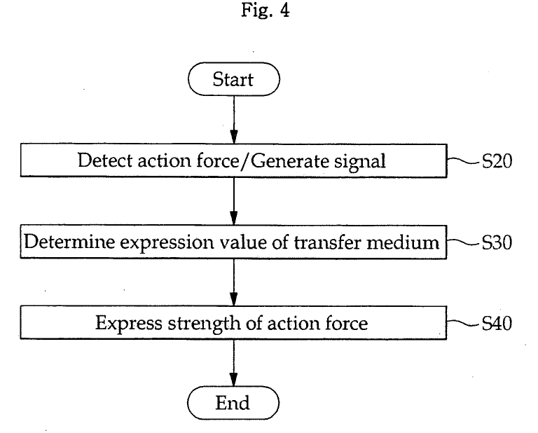

As shown in FIG. 4, a method for providing a user interface of the present invention largely comprises the steps of detecting an action force Fᵢₙ and generating a signal corresponding to the action force Fᵢₙ, by the tactile sensor 220 S20; determining, by the control unit 230, an expression value of a transfer medium based on the generated signal S30; and expressing the strength of the action force Fᵢₙ as the transfer medium based on the expression value S40.

(Step of Generating Signal: S20)

If a user applies an action force Fᵢₙ on the touch input unit 210, the tactile sensor 220 of the apparatus for providing a user interface generates a signal corresponding to the action force Fᵢₙ. When tactile sensors 220 are arranged on the bottom surface of the touch input unit 210 in the form of a matrix as shown in FIG. 2a, a tactile sensor 220 of a corresponding position where the action force Fᵢₙ is applied detects the action force Fᵢₙ and generates a corresponding signal. When the tactile sensors 220 are arranged along the edge of the touch input unit 210 as shown in FIG. 2b, a tactile sensor 220 placed in the neighborhood of the point where the action force Fᵢₙ is applied detects the action force Fᵢₙ and generates a corresponding signal. Unlike the case of FIG. 2a, this is a method of indirectly detecting the action force Fᵢₙ by the tactile sensors 220 placed in the neighborhood of the point where the action force Fᵢₙ is applied. Therefore, in order for a signal corresponding to the action force Fᵢₙ to have a valid value, it is preferable to use a maximum value, average value, or 3 dB value of the signals generated by respective tactile sensors 220.

(Step of Determining Expression Value of Transfer Medium: S30)

The control unit 230 of the apparatus for providing a user interface determines an expression value of a transfer medium based on the signal generated by the tactile sensor 220. When the transfer medium is an indicator icon, the expression value means an expression form of the indicator icon (a bar icon, gauge icon, 7-segment digital icon, or level meter icon) and a degree of displaying a color, bar, or gauge that expresses the strength of an action force Fᵢₙ. In addition, when a user selects a specific character, icon, or the like by inputting an action force Fᵢₙ, the expression value means a display size or the like of the selected specific character or icon.

When the transfer medium is a sound, the expression value means a type of the sound, the number of vibrations f or amplitude A of the sound corresponding to the action force Fᵢₙ, and the like. In addition, when the transfer medium is vibration, the expression value means amplitude A′ of the vibration and the number of vibrations f′ corresponding to the action force Fᵢₙ.

The transfer medium includes an indicator icon, sound, vibration, and the like as described above, and each of the transfer media will be described below.

(Step of Expressing Strength of Action Force as Indicator Icon: S40′)

In the step of expressing the strength of an action force Fᵢₙ as an indicator icon, the expression unit 240 of the apparatus for providing a user interface becomes the display unit 212.

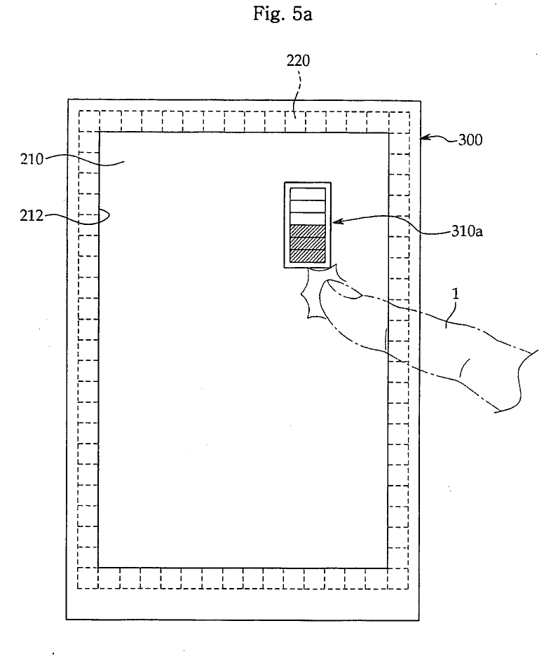

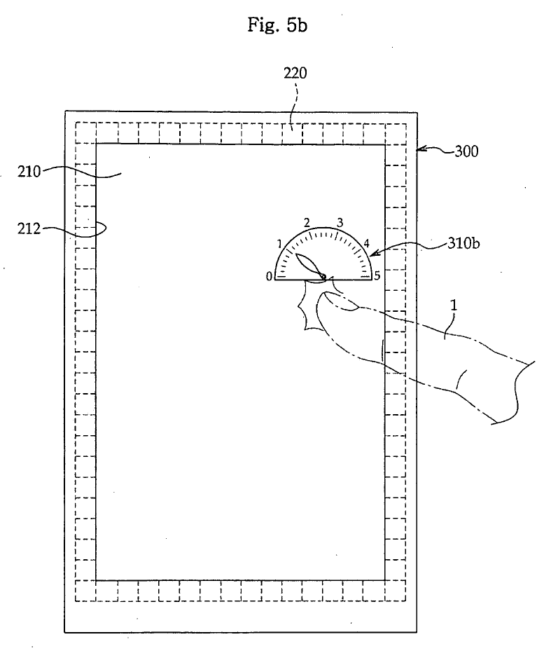

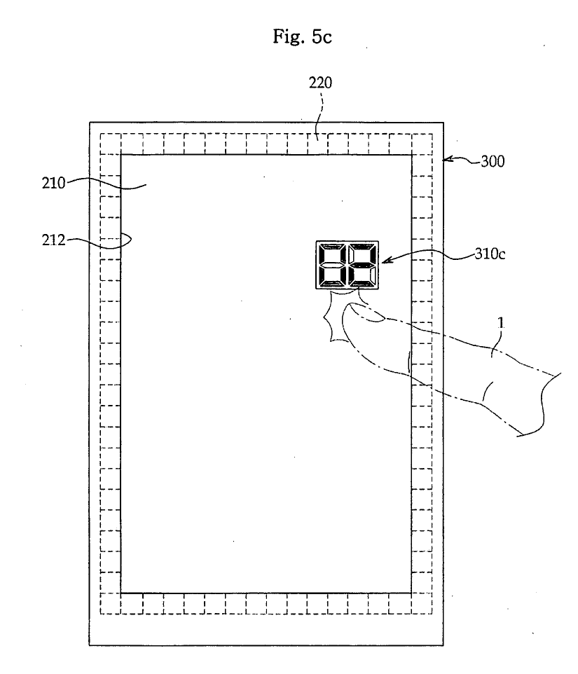

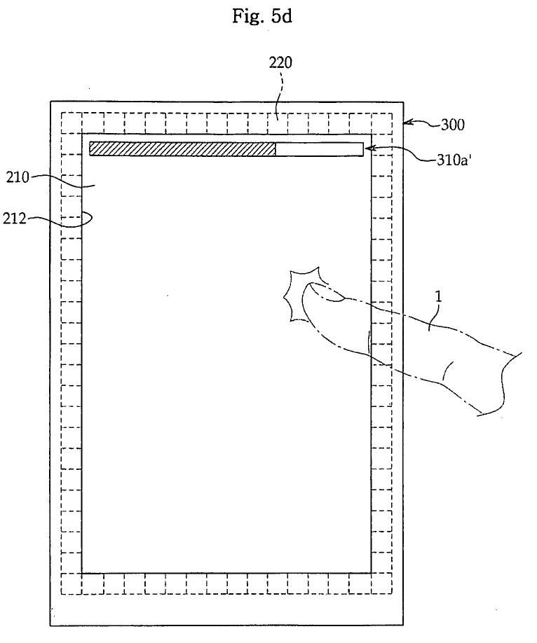

In the same manner as an icon for displaying remaining amount of a battery of a cellular phone is fixed at an upper portion of the display unit 212, the indicator icon may be generally displayed at a predetermined position of the display unit 212 as shown in FIG. 5d, irrespective of a point where the action force Fᵢₙ is applied. FIG. 5d shows an indicator icon 310a′ expressed in the form of a bar at a predetermined position (e.g., at an upper portion of the display unit) irrespective of a point where the action force Fᵢₙ is applied.

In addition, as shown in FIGS. 5a to 5c, the indicator icon is expressed also in a method of being displayed and disappeared at a corresponding position where the action force Fᵢₙ is applied. This method is further economical in the aspect of operating the display unit 212 considering the environment of the portable terminal 300 having a display unit 212 of a small size.

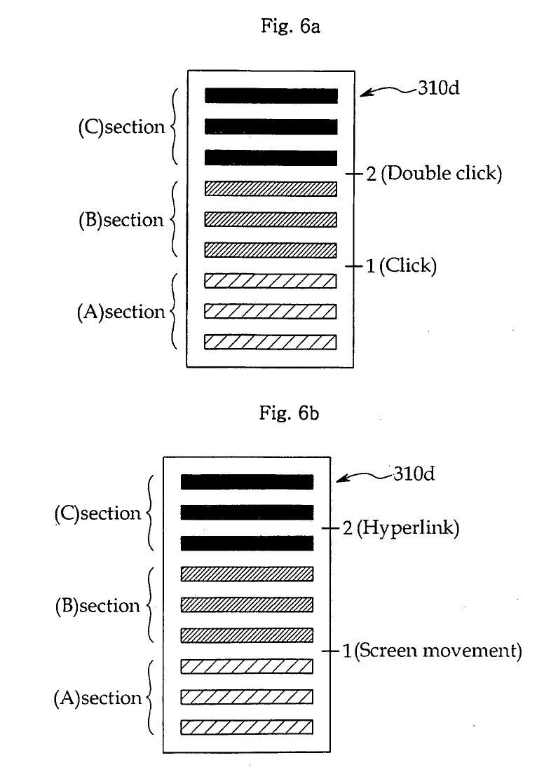

Then, since the indicator icon may be expressed in a variety of forms, it is preferable that a user previously selects one of the various icon expression forms in the portable terminal 300. The selected indicator icon form is detected, and then strength of an action force Fᵢₙ is displayed in the detected indicator icon form. At this point, the indicator icon expression form selected by the user includes bar icons 310a and 310a′, gauge icon 310b, 7-segment digital icon 310c, and level meter icon 310d as shown in FIGS. 5a to 5d and 6a to 6b.

In addition, as shown in FIGS. 6a and 6b, certain sections are set and displayed in colors different from one another depending on the strength of the action force Fᵢₙ. For example, after configuring section (A) in yellow, (B) in amber, and (C) in red, increase of the strength of the action force Fᵢₙ can be visually expressed.

Then, as shown in FIGS. 6a and 6b, the indicator icon preferably displays the change of an operation state (a click, movement of the screen, and the like) according to a click event generated by applying an action force Fᵢₙ, as well as the strength of the action force Fᵢₙ. For example, movement of a screen is described with reference to FIG. 6b. If it is set to move the screen up, down, left, and right when the action force Fᵢₙ is less than 2N and the screen is transferred to a screen of hyperlinked another web site according to generation of a click event when the action force Fᵢₙ is greater than 2N, the indicator icon preferably displays a phrase such as ‘movement of screen’, ‘hyperlink’, or the like, together with the strength of the action force Fᵢₙ, as shown in FIG. 6b. As another example, a ‘click’, and a ‘double click’ also can be implemented based on a change of the strength of the action force Fᵢₙ as shown in FIG. 6a, and thus it is preferable that these are expressed together with the change of the strength of the action force to be visually shown to the user.

When the strength of the action force Fᵢₙ is displayed as an indicator icon, a certain effect sound or vibration is preferably expressed together with the strength in order to give the user a feeling of a click. The amplitude A or A′ and frequency f or f′ of the effect sound or vibration are preferably proportional to the action force Fᵢₙ. In the case of the effect sound, the greater the action force Fᵢₙ is, the higher a pitch (increase of frequency) is outputted. In addition, the greater the action force Fᵢₙ is, the louder a sound (increase of strength) is outputted to the user, and thus an auditory expression may also be provided, as well as a visual expression provided through the indicator icons 310a, 310b, 310c, and 310d.

(Step of Expressing Strength of Action Force as Sound: S40″)

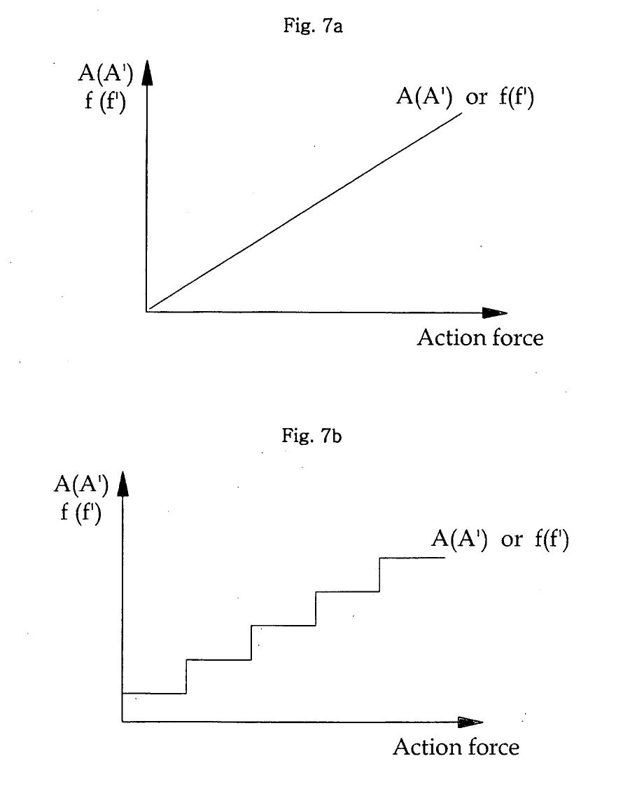

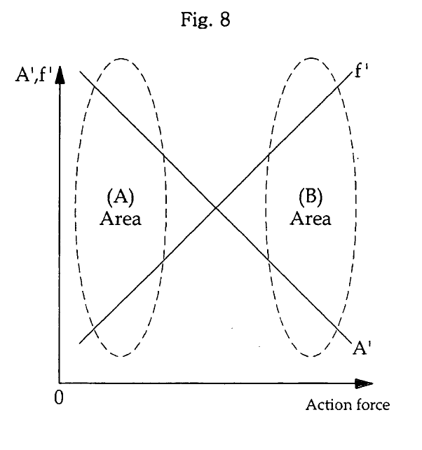

When strength of an action force Fᵢₙ is expressed as a sound, the expression unit 240 becomes a speaker of the portable terminal 300. Since the sound has a feature of being diversely expressed by changing a pitch, loudness, or the like of the sound, the strength of the action force Fᵢₙ can be expressed variously using the feature. Amplitude A and frequency f are parameters for determining the sound. FIGS. 7a and 7b are relation graphs showing the frequency f or amplitude A of a sound with respect to an action force Fᵢₙ. The x-axis of the graphs represents an action force Fᵢₙ, and the y-axis represents a relative magnitude of the amplitude A or frequency f.

As shown in FIG. 7a, the frequency f or amplitude A of a sound may be linearly proportional to an action force Fᵢₙ. As the action force Fᵢₙ is greater, a higher pitch can be outputted due to increase of the frequency f, or a louder sound can be outputted due to increase of the amplitude A. In this manner, a user may recognize the strength of the action force Fᵢₙ.

As shown in FIG. 7a, the frequency f or amplitude A of a sound may have a form of a step function depending on the relation with an action force Fᵢₙ. As shown in the graph, the action force Fᵢₙ is divided into certain sections, and the action force Fᵢₙ can be expressed by increasing the amplitude A or frequency f of the sound in each section.

Generally, a click event is generated in the portable terminal 300 as the action force Fᵢₙ is applied. In addition, the click event may be diversely configured in manners other than the examples described above, such as movement and hyperlink of a screen, click and double click, and the like. Therefore, it is preferable to visually express the change of an operation state according to the generation of the click event on the display unit 212, together with outputting a sound, in order to provide convenience for users.

(Step of Expressing Action Force as Vibration: S40′″)

In the step of expressing strength of an action force Fᵢₙ as vibration, the expression unit 240 becomes an actuator or a widely known vibration motor installed in a general cellular phone. Like a sound, vibration is advantageous in that it may have a variety of forms depending on parameters of amplitude A′ and frequency f. If such a feature of the vibration is used, the strength of an action force Fᵢₙ may be expressed in a variety of forms.

Like a sound, as shown in FIG. 7a, frequency f′ or amplitude A′ of vibration may be proportional to an action force Fᵢₙ. As the strength of the action force Fᵢₙ becomes greater, minute trembling is expressed to a user due to increase of the frequency f′, or a strong vibration may be expressed due to increase of the amplitude A′. Therefore, the user may feel the strength of the action force Fᵢₙ through tactile sense.

As shown in FIG. 7b, the frequency f′ or amplitude A′ of vibration may have a step function in a relation with the action force Fᵢₙ. Since description of those is the same as the step of expressing an action force as a sound S30″, it will not be described.

As shown in FIG. 8, the frequency f′ and amplitude A′ of vibration may be inverse proportional to the increase of an action force Fᵢₙ. Area (A) may transfer a soft feeling to a user, whereas area (B) may transfer a relatively hard feeling to a user. If the action force Fᵢₙ is comparatively weak, the strength of the action force may be expressed as vibration of area (A), and if the action force Fᵢₙ is comparatively strong, the strength of the action force may be expressed as vibration of area (B), and thus the user use may recognized the strength of the action force Fᵢₙ.

On the other hand, the vibration may be transferred using the whole touch input unit 210 or portable terminal 300 as a medium. That is, the vibration expressed to a user may be expressed only at a corresponding point where an action force Fᵢₙ is applied or expressed using the whole portable terminal 300, like vibration of a general cellular phone.

Then, in the steps of expressing the strength of an action force Fᵢₙ to a user as a sound and/or vibration S40′ and S40′″, the transfer medium is preferably outputted when the action force Fᵢₙ is greater than a certain critical force F_{cr}. If operation states of the portable terminal 300 are set differently depending on the strength of the action force Fᵢₙ, it is to allow a user to easily distinguish the operation states. The critical force F_{cr} means a reference value of an action force Fᵢₙ applied by a user for a position or operation command, at which an operation state of the portable terminal 300 is changed. Accordingly, the critical force F_{cr} is a value larger than the minimum force Fₘ that is referred when an apparatus for providing a user interface is described.

For example, it is assumed that the screen moves in the direction to a point where the user applies an action force Fᵢₙ if the action force Fᵢₙ is less than 1N, and the screen is clicked if the action force Fᵢₙ is greater than 1N (i.e., the critical force F_{cr} is 1N). In this case, if the action force Fᵢₙ applied by the user is less than 1N, the screen moves, but the strength is not expressed to the user. However, if the action force Fᵢₙ applied by the user is greater than 1N, the strength of the action force Fᵢₙ is expressed as an output of a sound and/or vibration at the same time as the screen is clicked. Therefore, the user may visually, aurally, and/or tactually distinguish the simple screen movement and click. However, it is preferable that the degree of the action force Fᵢₙ is expressed as an indicator icon while the action force Fᵢₙ is applied so that the user may know the degree of the strength of the action force Fᵢₙ applied by the user. In addition, even when an action force Fᵢₙ less than the critical force F_{cr} is applied and thus a transfer medium of a sound or vibration is not outputted, it will be preferable to display a state of screen movement (e.g., move to the left) on the screen in the form of a speech bubble or the like considering convenience of users in using the apparatus.

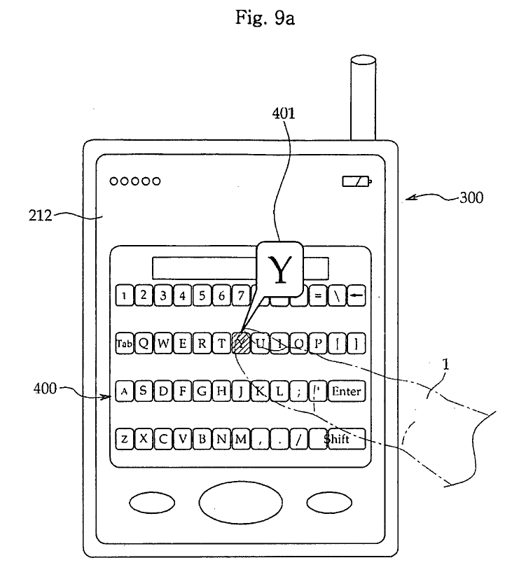

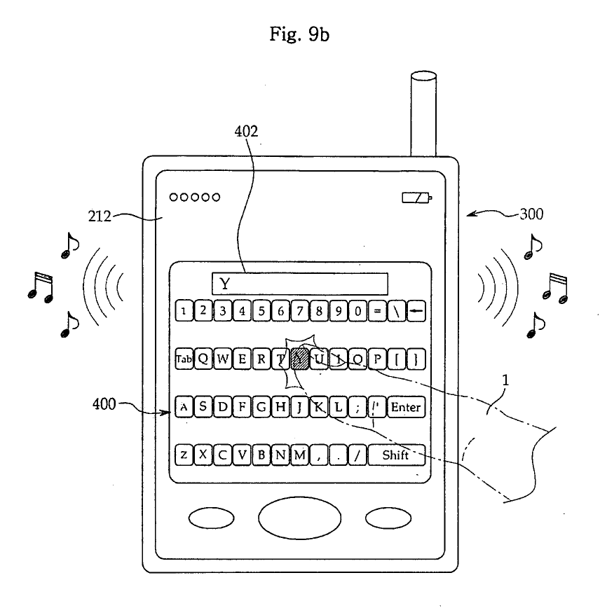

Still another example is described below with reference to FIGS. 9a and 9b. It is described that a user inputs letters in the portable terminal 300. In this case, it is assumed that the critical force F_{cr} is 1N. If the user selects ‘Y’ from a character input window 400 shown on the display unit 212 by applying an action force Fᵢₙ less than 1N, the fact that ‘Y’ is selected is shown to the user as an enlarged screen 401 (e.g., in the form of a speech bubble) without an output of a sound or vibration. In this manner, the user may confirm whether it is selected in accordance with his or her intention. If a letter is selected in accordance with his or her intention, the user inputs the selected letter Y by applying an action force Fᵢₙ greater than 1N. At this point, the selected letter Y is inputted, and a certain sound or vibration is outputted simultaneously. FIG. 9b shows output of a certain sound. It is apparent that the minimum force Fₘ or critical force F_{cr} can be previously set by the user in an environment setting mode of the portable terminal 300, or can be controlled to be changed later.

<Recording Medium>

A recoding medium for providing the user interface records a program for executing an action force detecting step for detecting application of an action force Fᵢₙ; a signal storing step for storing a signal generated by the tactile sensor 220; an expression value determining step for determining an expression value of a transfer medium based on the signal; and an expression step for expressing the action force as an indicator icon, sound, or vibration depending on the determined expression value.

In addition, such a recording medium can be read by a computing system included in the portable terminal 300 in which the apparatus for providing a user interface is installed. Such a computing system can be included in the control unit 230 or configured as an apparatus separate from the control unit 230.

The recording medium preferable includes a program for executing, before detecting application of the action force Fᵢₙ, a medium selecting step for allowing a user to select any one of an indicator icon, sound, and vibration as a medium for expressing strength of an action force Fᵢₙ in order to provide a user interface that is suitable to a user's taste.

In addition, when the action force Fᵢₙ is expressed as an indicator icon, it is preferable that the recording medium further includes a program for executing an icon selecting step for allowing a user to select in advance any one of display forms of a level meter icon, 7-segment digital icon, bar icon, and gauge icon.

<Modified Embodiment>

The apparatus and method for providing a user interface, and a recording method of the present invention can be used in all electronic/communication devices that input a position or operation command in a touch method, such as a cellular phone, a pocket device, a personal portable device (e.g., PDA or PMP) that can be used by a user with one hand, or the like.

As another embodiment, in the step of expressing an action force Fᵢₙ as an indicator icon S40′, when the indicator icon is divided into sections and each of the sections expresses a degree of an action force Fᵢₙ in a different color, it is apparent that the expression method can be applied to a bar icon, gauge icon, 7-segment digital icon, and the like, as well as a level meter icon as shown in FIGS. 6a and 6b.

As another embodiment, while strength of an action force Fᵢₙ is expressed as a transfer medium, change of operation according to generation of a click event can be simultaneously expressed in the form of creating a speech bubble. In addition, the change of operation may be diversely occurred by enlargement, reduction, and the like of the screen, in addition to a click, double click, screen movement, and hyperlink, as shown in FIGS. 6a and 6b.

As still another embodiment, although the steps of expressing an action force Fᵢₙ as an indicator icon S40′, expressing as a sound S40″, and expressing as vibration S40′″ are separately described, strength of an action force Fᵢₙ may be expressed as the three transfer media at the same time.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An apparatus for providing a user interface depending on an action force, the apparatus comprising:
a touch input unit for allowing a user to input a position or operation command thereto using a pointing object, being applied with the action force of the pointing object, and recognizing the applied position information;
a tactile sensor placed on a bottom surface of the touch input unit, for detecting the action force and generating a predetermined signal;
a control unit for determining an expression value of a transfer medium in response to the signal generated from the tactile sensor; and
an expression unit for expressing the strength of the action force by outputting the transfer medium based on the expression value of the control unit.

2. The apparatus according to claim 1, wherein the transfer medium is at least one of an indicator icon, sound, and vibration.

3. The apparatus according to claim 2, wherein the indicator icon is a level meter icon, 7-segment digital icon, bar icon, or gauge icon.

4. The apparatus according to claim 1, wherein the apparatus is operated when an action force greater than a minimum force previously set by a user is applied.

5. A method for providing a user interface depending on an action force, the method comprising the steps of:
allowing a tactile sensor to detect the action force and generate a signal corresponding to the action force;
allowing a control unit to determine an expression value of a transfer medium based on the signal generated from the tactile sensor; and
expressing the strength of the action force as an indicator icon based on the expression value.

6. The method according to claim 5, wherein the indicator icon is displayed at a previously specified position of a display unit of a portable terminal.

7. The method according to claim 5, wherein the indicator icon appears for a few seconds at a position where the action force is applied and then disappears.

8. The method according to claim 5, further comprising the step of allowing, before the step of allowing the tactile sensor to detect the action force and generate the signal corresponding to the action force, a user to select any one of indicator icon display forms of a level meter icon, 7-segment digital icon, bar icon, and gauge icon.

9. The method according to claim 5, wherein in the step of expressing the strength of the action force as an indicator icon, the indicator icon is divided into certain sections, and the divided sections are displayed in colors different from one another depending on the strength of the action force.

10. The method according to claim 5, wherein in the step of expressing the strength of the action force as an indicator icon, a certain sound or vibration is outputted together with the icon.

11. The method according to claim 10, wherein frequency or amplitude of the certain sound or vibration is proportional to the strength of the action force.

12. The method according to claim 5, wherein in the step of expressing the strength of the action force as an indicator icon, the change of an operation state according to a click event generated by applying the action force is displayed together with the icon.

13. A method for providing a user interface depending on an action force, the method comprising the steps of:
allowing a tactile sensor to detect the action force and generate a signal corresponding to the action force;
allowing a control unit to determine an expression value of a sound based on the signal generated from the tactile sensor; and
expressing the strength of the action force as the sound based on the expression value.

14. The method according to claim 13, wherein the amplitude or frequency of the sound is proportional to the strength of the action force.

15. The method according to claim 13, wherein the action force is divided into certain sections, and the amplitude or frequency of the sound is increased on a step function basis as the strength of the action force is increased in each section.

16. The method according to claim 13, wherein in the step of expressing the strength of the action force as a sound, the change of an operation state according to a click event generated by applying the action force is visually expressed together with the sound.

17. A method for providing a user interface depending on an action force, the method comprising the steps of:
allowing a user to apply the action force;
allowing a tactile sensor to detect the action force and generate a signal corresponding to the action force;
allowing a control unit to determine an expression value of a vibration based on the signal generated from the tactile sensor; and
expressing the strength of the action force as vibration based on the expression value.

18. The method according to claim 17, wherein the amplitude or frequency of the vibration is proportional to the strength of the action force.

19. The method according to claim 17, wherein the action force is divided into certain sections, and the amplitude or frequency of the vibration is increased on a step function basis as the strength of the action force is increased in each section.

20. The method according to claim 17, wherein in the step of expressing the strength of the action force as vibration, the change of an operation state according to a click event generated by applying the action force is visually expressed together with the vibration.

21. The method according to claim 13, wherein the sound is outputted when the action force is greater than a certain critical force.

22. The method according to claim 17, wherein the vibration is outputted when the action force is greater than a certain critical force.

23. A recording medium that is readable by a computing system included in an apparatus for providing a user interface depending on an action force, the medium having a program recorded thereon for executing:
an action force detecting step for detecting application of the action force;
a signal storing step for storing a signal corresponding to the action force generated by a tactile sensor;
an expression value determining step for determining an expression value of a transfer medium based on the signal; and
an expression step for expressing the strength of the action force as an indicator icon, sound, or vibration depending on the determined expression value.

24. The medium according to claim 23, further comprising a program for executing, before detecting application of the action force, a medium selection step that allows a user to previously select at least one of the indicator icon, sound, and vibration as a medium for expressing the strength of the action force.

25. The medium according to claim 23, further comprising a program for executing, when the strength of the action force is expressed as an indicator icon, an icon selection step for allowing a user to previously select at least one of indicator icon display forms of a level meter icon, 7-segment digital icon, bar icon, and gauge icon.
